(19) United States
(12) Patent Application Publication
(10) Pub. No.: US 2020/0211763 A1
(43) Pub. Date: Jul. 2, 2020

(54) INDUCTOR COMPONENT

(71) Applicant: Panasonic Intellectual Property Management Co., Ltd., Osaka (JP)

(72) Inventors: KEITO KATAOKA, Hyogo (JP); HIDEKI UEDA, Hyogo (JP)

(21) Appl. No.: 16/479,629

(22) PCT Filed: Mar. 16, 2018
(86) PCT No.: PCT/JP2018/010498

§ 371 Date: Jul. 22, 2019

(30) Foreign Application Priority Data
Apr. 3, 2017 (JP) 2017-073485

(51) Int. Cl. H01F 27/29; H01F 27/28; H01F 27/32

(52) U.S. Cl. CPC H01F 27/292; H01F 27/327; H01F 27/2823

(57) ABSTRACT

An inductor component includes a package, a coil embedded in the package, a first external electrode extending from a first end of the coil, and a second external electrode extending from a second end of the coil. The package has a bottom surface, a top surface, first and second side surfaces opposite to each other, and third and fourth side surfaces opposite to each other. The bottom surface of the package has a first step recess therein sinking toward the top surface, opening to the third side surface, and contacting the first external electrode. The bottom surface of the package further has a second step recess therein sinking toward the top surface, opening to the fourth side surface, and contacting the second external electrode. The bottom surface has a third step recess therein connected to the first step recess and sinking toward the top surface. The bottom surface has a fourth step recess therein connected to the second step recess and sinking toward the top surface. Upon being subjected to reflow-soldering, the inductor component enhances wettability to solder.

### TECHNICAL FIELD

The present invention relates to an inductor component for use in various electronics devices.

### BACKGROUND ART

Inductor components used in devices, such as DC-DC converters, around engines of vehicles have been used in high electric-current applications. To cope with such high-current applications, the devices have large sizes, and arise problems of vibration resistance in particular in automotive applications accordingly.

For inductor components for use in such high electric-current applications, the applicant of the application previously proposed an inductor component featuring improved vibration resistance (see PTL 1).

The inductor component disclosed in PTL 1 includes a package made of magnetic material in which a coil electrode is embedded. The coil electrode is made of a wound conductive wire. both ends of the coil electrode is led out from a side surface of the package, bent at its lead-out position toward the bottom surface of the package, further bent to extend along the bottom surface and along another side surface opposite to the above-described side surface, yet further bent to and then locked in a cutout provided in a top surface of the package. This forms external electrodes. The bottom surface of the package has step recesses therein provided at places where the external electrodes contact the bottom surface. A recess is provided in the package in each of the step recesses. The external electrode is curved toward the recess.

This configuration allows the external electrodes to be disposed along the bottom surface from one edge to the other, and to be curved toward the respective recesses, and allows the external electrodes to securely contact the package, hence improving vibration resistance of the component.

### CITATION LIST

### Patent Literature

PTL 1: Japanese Patent Laid-Open Publication No. 2014-132630

### SUMMARY

An inductor component includes a package, a coil embedded in the package, a first external electrode extending from a first end of the coil, and a second external electrode extending from a second end of the coil. The package has a bottom surface, a top surface, first and second side surfaces opposite to each other, and third and fourth side surfaces opposite to each other. The bottom surface of the package has a first step recess therein sinking toward the top surface, opening to the third side surface, and contacting the first external electrode. The bottom surface of the package further has a second step recess therein sinking toward the top surface, opening to the fourth side surface, and contacting the second external electrode. The bottom surface has a third step recess therein connected to the first step recess and sinking toward the top surface. The bottom surface has a fourth step recess therein connected to the second step recess and sinking toward the top surface.

Upon being subjected to reflow-soldering, the inductor component enhances wettability to solder.

### BRIEF DESCRIPTION OF DRAWINGS

FIG. 1 is a top perspective view of an inductor component according to an exemplary embodiment.

FIG. 2 is a bottom plan view of the inductor component shown in FIG. 1.

FIG. 3A is a side view of the inductor component shown in FIG. 1.

FIG. 3B is a side view of the inductor component shown in FIG. 1.

FIG. 4 is a bottom perspective view of the inductor component shown in FIG. 1.

FIG. 5 is a bottom perspective view of a package of the inductor component shown in FIG. 1.

FIG. 6 is a bottom plan view of another inductor component according to the embodiment.

FIG. 7 is a bottom perspective view of the inductor component shown in FIG. 6.

FIG. 8 is a bottom perspective view of a package of the inductor component shown in FIG. 6.

FIG. 9 is a bottom plan view of still another inductor component according to the embodiment.

FIG. 10 is a bottom perspective view of the inductor component shown in FIG. 9.

FIG. 11 is a bottom perspective view of a package of the inductor component shown in FIG. 9.

### DETAIL DESCRIPTION OF PREFERRED EMBODIMENT

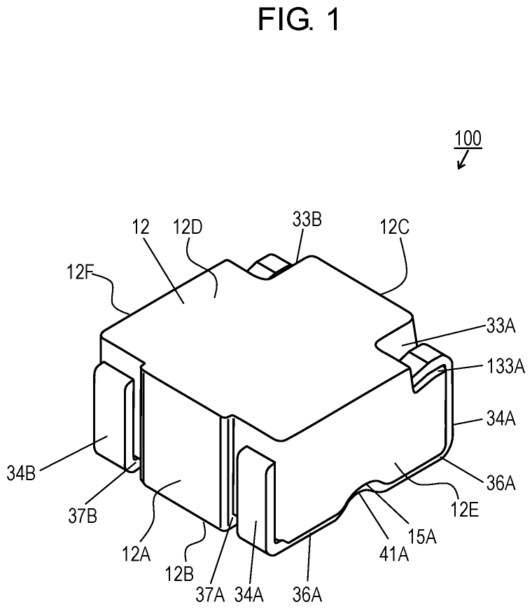

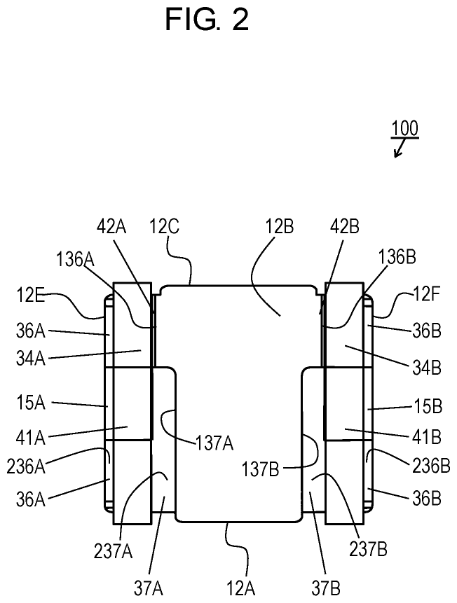

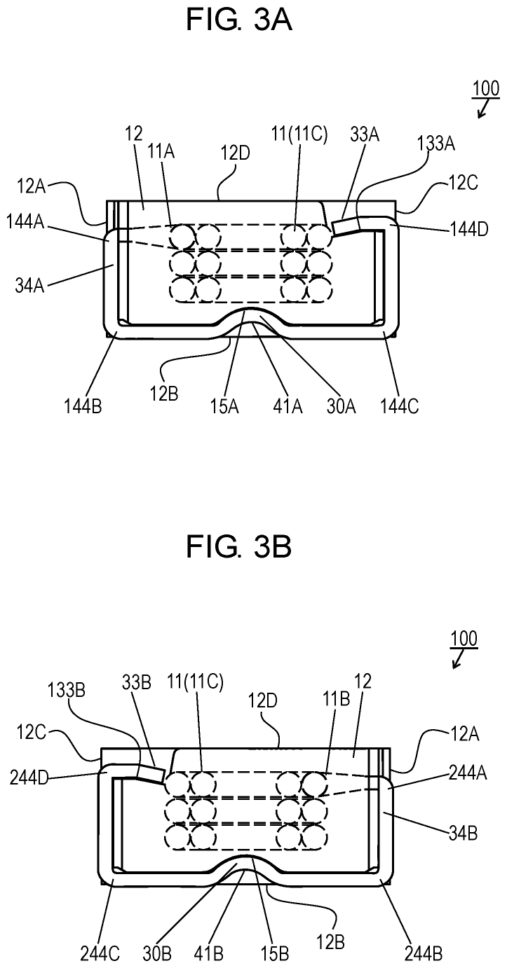

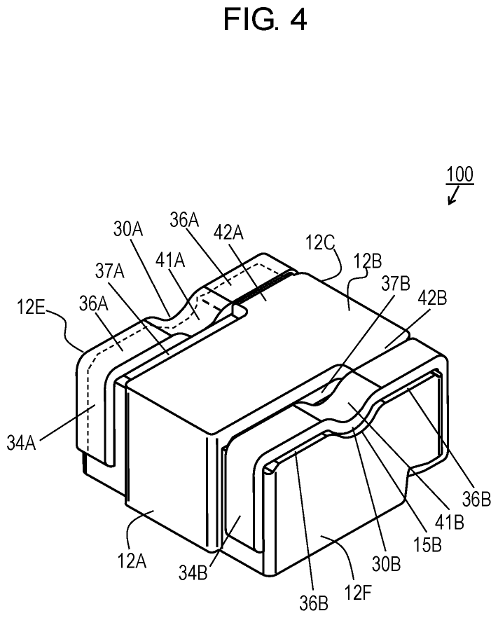

FIG. 1 is a top perspective view of inductor component 100 according to an exemplary embodiment. FIG. 2 is a bottom plan view of inductor component 100. FIGS. 3A and 3B are side views of inductor component 100. FIG. 4 is a bottom perspective view of inductor component 100.

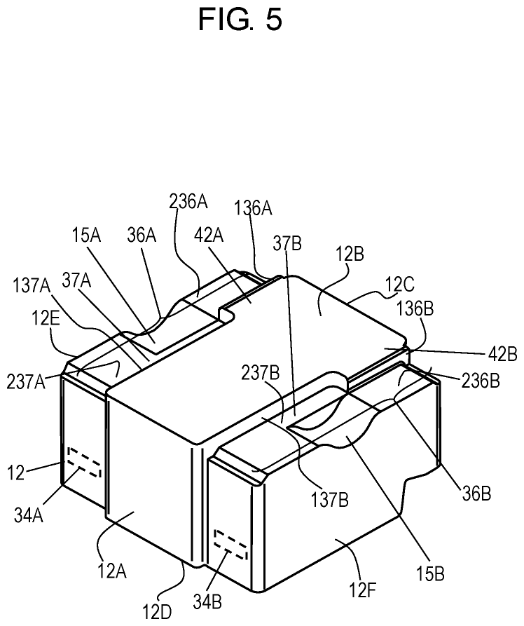

Inductor component 100 includes coil 11, package 12, and external electrodes 34A and 34B. FIG. 5 is a bottom perspective view of package 12.

Package 12 is made of magnetic material. Coil 11 is embedded in package 12. In FIGS. 3A and 3B, coil 11 embedded in the package is indicated by dashed lines. Coil 11 is made of wound conductive wire 11C having ends 11A and 11B.

Package 12 includes: bottom surface 12B, top surface 12D opposite to bottom surface 12B, side surface 12A, side surface 12C opposite to side surface 12A, side surface 12E connected to side surface 12A and side surface 12C, and side surface 12F opposite to side surface 12E. Side surface 12A is connected to top surface 12D and bottom surface 12B. Side surface 12C is connected to top surface 12D and bottom surface 12B. Side surface 12E is connected to top surface 12D, bottom surface 12B, and side surfaces 12A and 12C. Side surface 12F is connected to top surface 12D, bottom surface 12B, and side surfaces 12A and 12C. The top surface has cutouts 33A and 33B provide therein.

External electrode 34A extends from end 11A of coil 11, is led out from side surface 12A of package 12, is bent at bent portion 144A toward bottom surface 12B so as to extend along side surface 12A, and is further bent at bent portion 144B toward side surface 12C so as to extend along bottom surface 12B. Then, external electrode 34A is further bent at bent portion 144C toward top surface 12D so as to extend along side surface 12C, is further bent at bent portion 144D toward cutout 33A of top surface 12D, and is engaged with cutout 33A.

External electrode 34B extends from end 11B of coil 11, is led out from side surface 12A of package 12, is bent at bent portion 244A toward bottom surface 12B so as to extend along side surface 12A, and is further bent at bent portion 244B toward side surface 12C so as to extend along bottom surface 12B. Then, external electrode 34B is further bent at bent portion 244C toward top surface 12D so as to extend along side surface 12C, is further bent at bent portion 244D toward cutout 33B of top surface 12D, and is engaged with cutout 33B.

Bottom surface 12B has step recess 36A therein which sinks toward top surface 12D. Step recess 36A is provided at a place where external electrode 34A contacts the bottom surface from the side surface 12E. Step recess 36A sinks toward top surface 12D by a depth smaller than the thickness of external electrode 34A. Step recess 36A has side wall 136A and bottom 236A. Side wall 136A is connected to bottom surface 12B. Bottom 236A is connected to side wall 136A and side surface 12E. Side wall 136A faces in the same direction as side surface 12E. Bottom 236A faces in the same direction as bottom surface 12B. Dimple 15A is provided in bottom surface 12B in step recess 36A at a portion of step recess 36A overlapping external electrode 34A. External electrode 34A includes projection 30A that is curved to protrude into dimple 15A.

Bottom surface 12B has step recess 36B therein which sinks toward top surface 12D. Step recess 36B is provided at a place where external electrode 34B contacts the bottom surface from the side surface 12F. Step recess 36B sinks toward top surface 12D by a depth smaller than the thickness of external electrode 34B. Step recess 36B has side wall 136B and bottom 236B. Side wall 136B is connected to bottom surface 12B. Bottom 236B is connected to both side wall 136B and side surface 12F. Side wall 136B faces in the same direction as side surface 12F. Bottom 236B faces in the same direction as bottom surface 12B. Dimple 15B is provided in bottom surface in step recess 36B at a portion of step recess 36B overlapping external electrode 34B. External electrode 34B includes projection 30B that is curved to protrude into dimple 15B.

Bottom surface 12B further has step recesses 37A and 37B therein that are connected to step recesses 36A and 36B, respectively. Step recesses 37A and 37B sink toward top surface 12D, thereby configuring inductor component 100. Step recess 37A has side wall 137A and bottom 237A. Side wall 137A is connected to bottom surface 12B. Bottom 237A is connected to side wall 137A and bottom 236A of step recess 36A. Side wall 137A faces in the same direction as side surface 12E. Bottom 237A faces in the same direction as bottom surface 12B. Step recess 37B has side wall 137B and bottom 237B. Side wall 137B is connected to bottom surface 12B. Bottom 237B is connected to both side wall 137B and bottom 236B of step recess 36B. Side wall 137B faces in the same direction as side surface 12F. Bottom 237B faces in the same direction as bottom surface 12B. Side wall 137A of step recess 37A is located farther from external electrode 34A than side wall 136A of step recess 36A is. Side wall 137B of step recess 37B is located farther from external electrode 34B than side wall 136B of step recess 36B is.

Coil 11 is formed by helically winding conductive wire 11C. Wire 11C is made of, e.g. copper, and has a surface coat with an insulating material. Coil 11 is embedded in package 12 by placing the coil in a mixture of a magnetic powder and a binder, and pressure-molding the mixture. The magnetic powder is metal powder that is fabricated by, e.g. atomizing Fe—Si—Cr alloy into powder. Conductive wire 11C is, e.g. a round wire having a round cross section with a diameter of about 1.6 mm. Package 12 has bottom surface 12B having a size of about 15 mm by 15 mm, and the height of the package from bottom surface 12B to top surface 12D is about 8 mm.

Both ends 11A and 11B of conductive wire 11C of coil 11 are connected to external electrodes 34A and 34B, respectively. External electrodes 34A and 34B are led out from side surface 12A of package 12 at bent portions 144A and 244A, are bent at bent portions 144A and 244A toward bottom surface 12B, respectively. External electrodes 34A and 34B are bent to extend along bottom surface 12B, bent to extend along side surface 12C, and bent toward cutouts 33A and 33B provided in top surface 12D, respectively. Ends of external electrodes 34A and 34B are engaged with cutouts 33A and 33B, respectively. External electrodes 34A and 34B thus extend from side surface 12A to side surface 12C across bottom surface 12B,

The insulating material is removed from portions of the surface of the conductive wire of coil 11 led out from side surface 12A, thereby forming external electrodes 34A and 34B. The portion of the conductive wire having the insulating material removed is fixed along side surface 12A, bottom surface 12B, and side surface 12C. The portions of the conductive wire constituting external electrodes 34A and 34B are processed to have plate shapes by pressing the round wires. The thickness of the plate shapes of external electrodes 34A and 34B are, e.g. about 0.8 mm. Coil 11 may be made of, e.g. a rectangular wire other than the round wire. In this case, external electrodes 34A and 34B may be formed by deforming both ends 11A and 11B of coil 11 to have plate shapes.

Step recesses 36A and 36B sink from bottom surface 12B toward top surface 12D by depths smaller than the thickness of external electrodes 34A and 34B. External electrodes 34A and 34B are disposed along bottom surface 12B and contact step recesses 36A and 36B, thereby causing surfaces of external electrodes 34A and 34B opposite to package 12 to be located lower than bottom surface 12B. The surfaces of external electrodes 34A and 34B opposite to package 12 function as mounting surfaces of the component to be mounted on a circuit board. The depth of step recesses 36A and 36B is, e.g. 0.6 mm. The deeper the depth of step recesses 36A and 36B, the smaller the height of inductor component 100 is.

Cutout 33A has bottom 133A that is located closer to bottom surface 12B than top surface 12D is. Cutout 33B has bottom 133B that is located closer to bottom surface 12B than top surface 12D is. The ends of external electrodes 34A and 34B are preferably bent to be put on bottoms 133A and 133B, respectively.

The ends of coil 11 are thus bent toward respective cutouts 33A and 33B provided in top surface 12D of package 12 so as to fix the ends as external electrodes 34A and 34B. However, external electrodes 34A and 34B may extend not entirely along side surface 12A, bottom surface 12B, and side surface 12C. In this case, external electrodes 34A and 34B tend to contact points on corners of package 12. That is, external electrodes 34A and 34B tend to contact package 12 such that the electrodes are away from side surface 12A, bottom surface 12B, and side surface 12C, and contact only a ridge where side surface 12A is connected to bottom surface 12B and a ridge where bottom surface 12B is connected to side surface 12C.

In inductor component 100 according to the embodiment, dimples 15A and 15B are provided in bottom surface 12B in step recesses 36A and 36B at portions of step recesses 36A and 36B overlapping external electrodes 34A and 34B, respectively. External electrodes 34A and 15B are curved toward dimples 15A and 15B, thereby allowing external electrodes 34A and 34B to be tightly fixed to package 12. As a result, such curving of external electrodes 34A and 34B causes them to have projections 30A and 30B that are curved to protrude into dimples 15A and 15B, respectively. The depth of dimples 15A and 15B is, e.g. about 1.0 mm. This configuration allows external electrodes 34A and 34B to surface contact side surface 12A, bottom surface 12B, and side surface 12C. Dimples 15A and 15B are disposed at places except the ridge where bottom surface 12B is connected to side surface 12A and the ridge where bottom surface 12B is connected to side surface 12C.

Step recess 37A is located more inside than step recess 36A, and connected to step recess 36A. Step recess 37B is located more inside than step recess 36B, is connected to step recess 36B. That is, side wall 137A of step recess 37A is connected to side wall 136A of step recess 36A, and side wall 137B of step recess 37B is connected to side wall 136B of step recess 36B. This configuration allows external electrode 34A to be exposed at a place where step recess 37A is connected to step recess 36A, and allows external electrode 34B to be exposed at a place where step recess 37B is connected to step recess 36B.

In coping with increasing higher-current applications, the conventional inductor component disclosed in PTL 1 raises a problem as follows: The inductor component requires a thick conductive wire for the coil electrode, which increase the size of the component. This, in turn, decreases wettability of solder when the inductor component is mounted on a circuit board by reflow soldering.

The reason for this is as follows: Such a thick conductive wire, which configures the component's external electrodes as well, causes the external electrodes to be hardly heated. The thick conductive wire requires a large depth of the recesses provided in the package of the component, which results in an increase of hidden parts of the external electrodes which are partly hidden within the recesses. This raises the proportion of such hidden parts, particularly inside the external electrodes made of the thick wire, which in turn causes the external electrodes to be hardly heated.

In inductor component 100 according to the embodiment, as described above, external electrode 34A is exposed at the place where step recess 37A is connected to step recess 36A, and external electrode 34B is exposed at the place where step recess 37B is connected to step recess 36B. When inductor component 100 is mounted on a circuit board by reflow soldering, this configuration allows hot air, a hot atmosphere, generated by preheating and heating with a reflow furnace to flow onto inner sides of external electrodes 34A and 34B. This configuration facilitates the heating of external electrodes 34A and 34B, and enhancing wettability of external electrodes 34A and 34B to solder accordingly.

As a result, when inductor component 100 is mounted on a circuit board by reflow soldering, the configuration facilitates the forming of solder fillets at an areas on the inner sides of external electrodes 34A and 34B adjacent to step recesses 37A and 37B, respectively. Such areas are located between external electrode 34A and side wall 137A of step recess 37A, and located between external electrode 34B and side wall 137B of step recess 37B. This results in an increase resistance to vibration of inductor component 100.

In this case, step recesses 37A and 37B are preferably connected to side surface 12A so as to open at places where step recesses 37A and 37B are connected to side surface 12A. This configuration causes parts of external electrodes 34A and 34B that extends along side surface 12A to be closer to coil 11 embedded in package 12 than portions of the external electrodes that extend along bottom surface 12B. This configuration has a difficulty, for example, that external electrodes 34A and 34B tend to be hardly heated sufficiently since heat of external electrodes 34A and 34B is absorbed by coil 11. This is attributed to high thermal conductivity of coil 11 made of conductive wire 11C made of copper. In inductor component 100 according to the embodiment, step recesses 37A and 37B are connected to side surface 12A while opening at the respective places where step recesses 37A and 37B are connected to side surface 12A. This configuration allows hot air, a hot atmosphere, generated by a reflow furnace to flow from side surface 12A onto the inner sides of external electrodes 34A and 34B, thereby facilitating the heating of portions of external electrodes 34A and 34B which extend along side surface 12A. This increases in wettability of external electrodes 34A and 34B to solder.

External electrodes 34A and 34B have depressions 41A and 41B therein that sink toward dimples 15A and 15B, respectively. Step recesses 37A and 37B are preferably connected to depressions 41A and 41B of external electrodes 34A and 34B, respectively. This configuration allows hot air, a hot atmosphere, generated by a reflow furnace to flow between side surface 12A and each of side surfaces 12E and 12F through step recesses 37A and 37B and depressions 41A and 41B. This configuration facilitates the heating of depressions 41A and 41B and parts of external electrodes 34A and 34B which extend along side surface 12A.

The depth of step recesses 37A and 37B from bottom surface 12B is preferably smaller than the thickness of external electrodes 34A and 34B. If step recesses 37A and 37B have depths larger than the thickness of external electrodes 34A and 34B, the effect that hot air or a hot atmosphere generated by a reflow furnace sufficiently flows to external electrodes 34A and 34B is not much improved. Such large depts of step recesses 37A and 37B reduce the volume of package 12, leading to deteriorated magnetic characteristics. The depth of step recesses 37A and 37B from bottom surface 12B is preferably equal to or smaller than the depth of step recesses 36A and 36B from bottom surface 12B. The depth of step recesses 36A and 36B from bottom surface 12B is, e.g. 0.6 mm.

Step recesses 37A and 37B may be provided entirely over bottom surface 12B, i.e. from side surface 12A to side surface 12C. However, the bottom surface of package 12 preferably include non-recessed portions 42A and 42B where step recesses 37A and 37B are not formed at portions between side surfaces 12A and 12C. This configuration allows external electrodes 34A and 34B to be easily positioned by placing external electrodes 34A and 34B such that the inner sides of the external electrodes contact non-recessed portions 42A and 42B, i.e. side walls 136A and 136B of step recesses 36A and 36B, respectively, when external electrodes 34A and 34B are bent at bent portions 144A and 244 so as to be placed along bottom surface 12B. Moreover, the configuration enhances the strength of inductor component 100 against forces in a direction perpendicular to the direction in which external electrodes 34A and 34B extend, that is, forces in a direction in which side surface 12E and side surface 12F are arranged.

As described above, package 12 has bottom surface 12B, top surface 12D opposite to bottom surface 12B, side surface 12A connected to bottom surface 12B and top surface 12D, side surface 12C connected to bottom surface 12B and top surface 12D, side surface 12E connected to bottom surface 12B, top surface 12D, side surface 12A, and side surface 12C; and side surface 12F connected to bottom surface 12B, top surface 12D, side surface 12A, and side surface 12C. Side surface 12C is opposite to side surface 12A. Side surface 12F is opposite to side surface 12E. Coil 11 is made of would conductive wire 11C having ends 11A and 11B, and is embedded in package 12. External electrode 34A extends from end 11A of conductive wire 11C of coil 11, is led out from side surface 12A, is bent toward bottom surface 12B, is bent to extend along from side surface 12A through bottom surface 12B to side surface 12C, and is bent to top surface 12D. External electrode 34B extends from end 11B of conductive wire 11C of coil 11, is led out from side surface 12A. is bent toward bottom surface 12B, is bent to extend along from side surface 12A through bottom surface 12B to side surface 12C, and is bent to top surface 12D. Bottom surface 12B has step recess 36A therein that sinks toward top surface 12D. Step recess 36A opens at side surface 12E, and contacts external electrode 34A. Bottom surface 12B has step recess 36B therein that sinks toward top surface 12D. Step recess 36B opens at side surface 12F, and contacts external electrode 34B. Simple 15A is formed in the package in step recess 36A at a portion of step recess 36A overlapping external electrode 34A. External electrode 34A includes projection 30A that is curved to protrude into dimple 15A. Dimple 15B is formed in the package in step recess 36B at a portion of step recess 36B overlapping external electrode 34B. External electrode 34B includes projection 30B that is curved to protrude into dimple 15B. Bottom surface 12B has step recess 37A therein that is connected to step recess 36A and that sinks toward top surface 12D. Bottom surface 12B has step recess 37B therein that is connected to step recess 36B and that sinks top surface 12D.

Step recess 37A may be connected to side surface 12A, and step recess 37B may be connected to side surface 12A.

External electrode 34A may have depression 41A therein that sinks toward dimple 15A so as to be connected to step recess 37A. External electrode 34B may have depression 41B therein that sinks toward dimple 15B so as to be connected to step recess 37B.

Step recess 37A may be connected to depression 41A of external electrode 34A. Step recess 37B may be connected to depression 41B of external electrode 34B.

Top surface 12D of package 12 may have cutouts 33A and 33B provided therein. External electrode 34A may extend to cutout 33A of top surface 12D. External electrode 34B may extend to cutout 33B of top surface 12D.

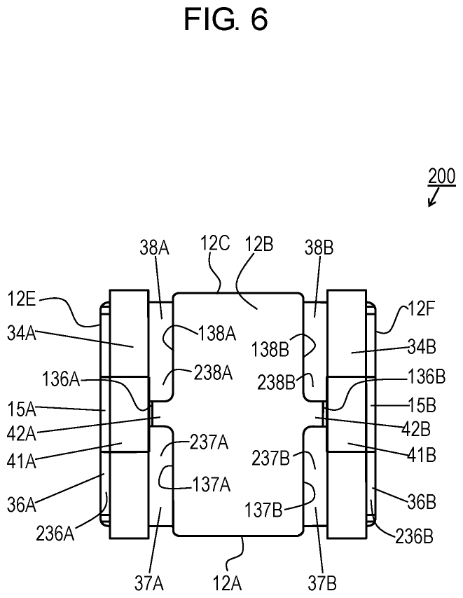

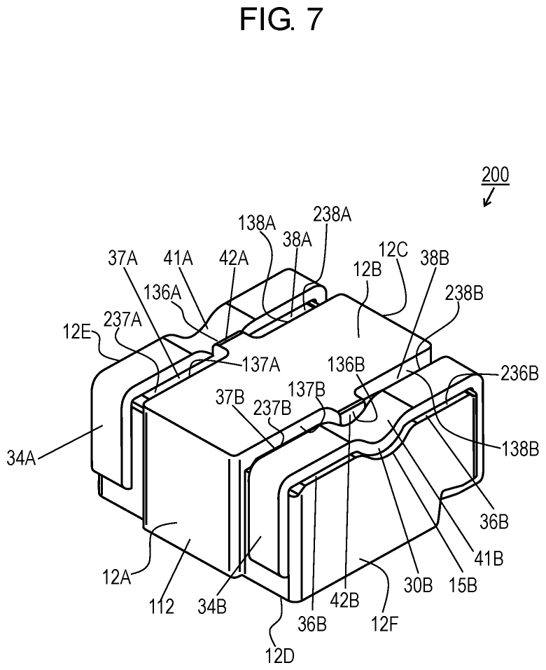

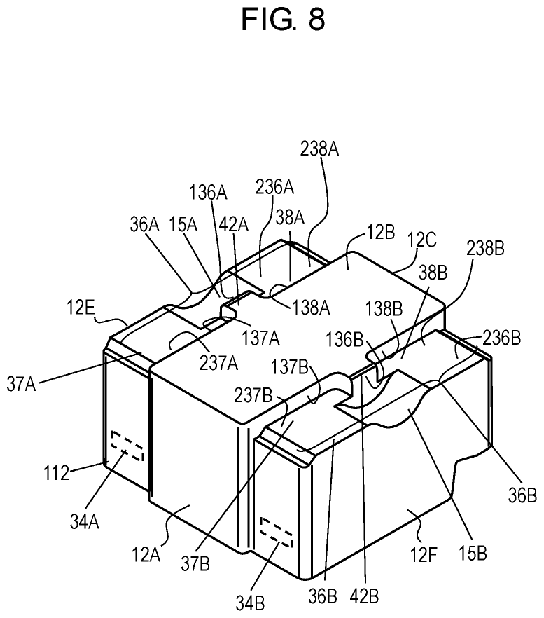

FIG. 6 is a bottom plan view of another inductor component 200 according to the embodiment. FIG. 7 is a bottom perspective view of inductor component 200. In FIGS. 6 and 7, components identical to those of inductor component 100 shown in FIGS. 1 to 5 are denoted by the same reference numerals. Instead of package 12 of inductor component 100 shown in FIGS. 1 to 5, inductor component 200 shown in FIGS. 6 and 7 includes package 112 made of the same material as package 12. FIG. 8 is a bottom perspective view of package 112.

Bottom surface 12B of package 112 further has step recesses 38A and 38B provided therein. Step recess 38A is disposed in an area on the inner side of step recess 36A, is connected to step recess 36A, extends to side surface 12C, and sinks toward top surface 12D. Step recess 38B is disposed in an area on the inner side of step recess 36B, is connected to step recess 36B, extends to side surface 12C, and sinks toward top surface 12D. Non-recessed portions 42A and 42B are disposed between step recesses 37A and 38A such that step recess 37A extending to side surface 12A is not connected to step recess 38A extending to side surface 12C.

In inductor component 200, step recesses 38A and 38B are located more inside than step recesses 36A and 36B, respectively. Thus, external electrode 34A is exposed at a place where step recess 38A and step recess 36A which reach side surface 12C are connected to each other. External electrode 34B is exposed at a place where step recess 38B and step recess 36B which reach side surface 12C are connected to each other. This configuration allows hot air, a hot atmosphere, generated by preheating and heating with a reflow furnace to blow onto portions of external electrodes 34A and 34B which reach side surface 12C when inductor component 200 is mounted on a circuit board by reflow soldering. Therefore, when inductor component 200 is mounted on the circuit board by reflow soldering, this configuration facilitates the heating of external electrodes 34A and 34B, accordingly enhancing wettability of external electrodes 34A and 34B to solder.

Step recesses 36A, 37A, and 38A has side walls 136A, 137A, and 138A and bottoms 236A, 237A, and 238A, respectively. Side walls 136A, 137A, and 138A are connected to bottom surface 12B. Bottoms 236A, 237A, and 238A are connected to side walls 136A, 137A, and 138A, respectively. In accordance with the embodiment, bottoms 236A, 237A, and 238A are flush with one another. In connection with non-recessed portion 42A, step recess 36A has side wall 136A that allows external electrode 34A to be positioned easily by placing external electrode 34A to contact side wall 136A. Side wall 138A of step recess 38A is located farther from external electrode 34A than side wall 136A of step recess 36A is.

Step recesses 36B, 37B, and 38B has side walls 136B, 137B, and 138B and bottoms 236B, 237B, and 238B. Side walls 136B, 137B, and 138B are connected to bottom surface 12B. Bottoms 236B, 237B, and 238B are connected to side walls 136B, 137B, and 138B, respectively. In accordance with the embodiment, bottoms 236B, 237B, and 238B are flush with one another. In connection with the configuration of non-recessed portion 42B, step recess 36B has side wall 136B that allows external electrode 34B to be positioned easily by placing external electrode 34B to contact side wall 136B. Side wall 138B of step recess 38B is located farther from external electrode 34B than side wall 136B of step recess 36B is. The configuration enhances the strength of inductor component 200 against forces in a direction perpendicular to the direction in which external electrodes 34A and 34B extend, that is, forces in a direction in which side surface 12E and side surface 12F are arranged.

Both step recess 37A connected to side surface 12A and step recess 38A connected to side surface 12C are preferably connected to depression 41A of external electrode 34A while both step recess 37B connected to side surface 12A and step recess 38B connected to side surface 12C are preferably connected to depression 41B of external electrode 34B. This configuration allows hot air, a hot atmosphere, generated by a reflow furnace to flow from both side surface 12E and side surface 12F through step recesses 37A and 37B and depressions 41A and 41B to spaces between side surface 12A and external electrodes 34A and 34B, respectively, or vice versa. The hot air also flows from both side surface 12E and side surface 12F, through step recesses 38A and 38B and depressions 41A and 41B, to spaces between side surface 12C and external electrodes 34A and 34B, respectively, or vice versa. This configuration further facilitating the heating of depressions 41A and 41B and parts of external electrodes 34A and 34B which extend along side surfaces 12A and 12C.

Bottom surface 12B has step recess 38A therein that is connected to step recess 36A and that sinks toward top surface 12D. Bottom surface 12B has step recess 38B therein that is connected to step recess 36B and that sinks toward top surface 12D. Step recess 37A is not connected to step recess 38A. Step recess 37B is not connected to step recess 38B.

Step recess 37A and step recess 38A are connected to depression 41A of external electrode 34A that sinks toward dimple 15A. Step recess 37B and step recess 38B are connected to depression 41B of external electrode 34B that sinks toward dimple 15B.

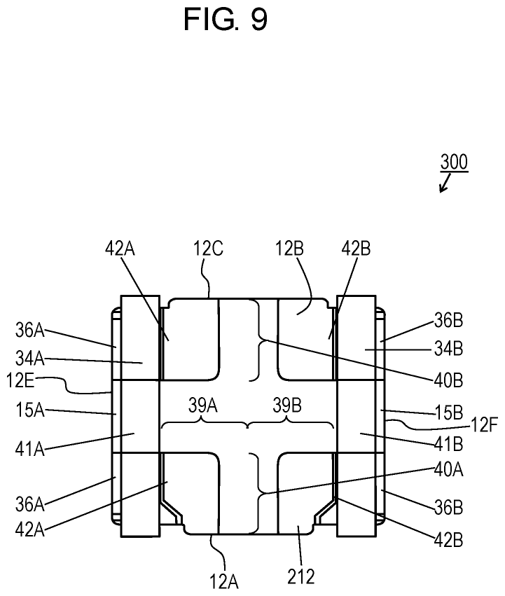

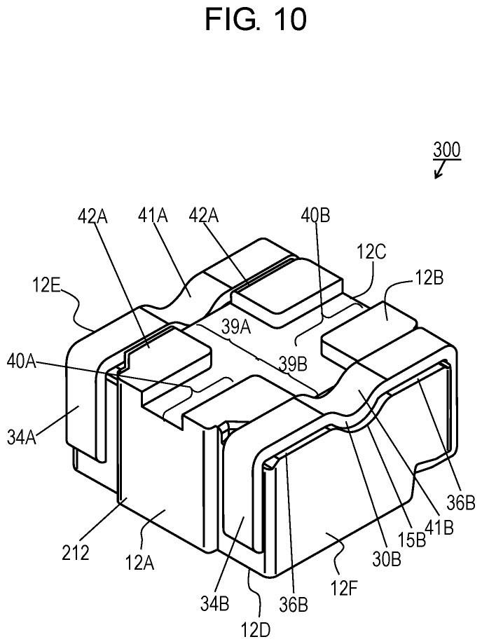

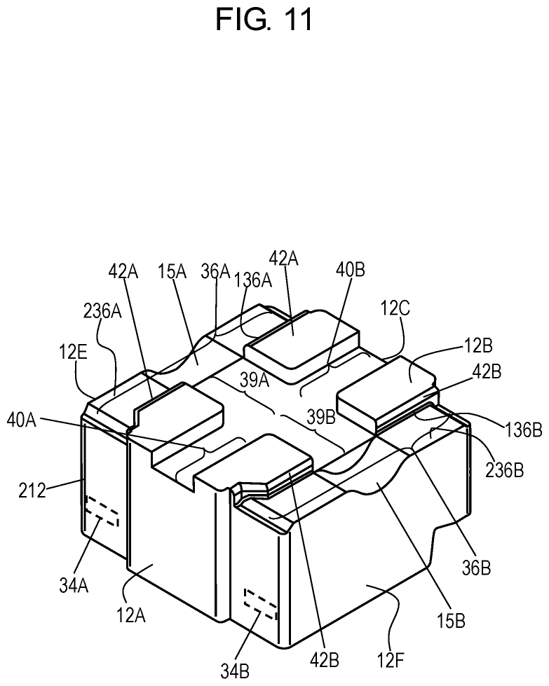

FIG. 9 is a bottom plan view of still another inductor component 300 according to the embodiment. FIG. 10 is a bottom perspective view of inductor component 300. In FIGS. 9 and 10, components identical to those of inductor component 100 shown in FIGS. 1 to 5 are denoted by the same reference numerals. Instead of package 12 of inductor component 100 shown in FIGS. 1 to 5, inductor component 300 includes package 212 made of the same material as package 12. FIG. 11 is a bottom perspective view of package 212.

Instead of step recesses 37A and 37B shown in FIGS. 1 to 5, bottom surface 12B of package 212 has step recesses 39A and 39B therein that are connected to depressions 41A and 41B of external electrodes 34A and 34B, respectively. Step recesses 39A and 39B are connected to each other.

Step recesses 39A and 39B allow hot air, a hot atmosphere, generated by a reflow furnace to flow from side surface 12E to side surface 12F, or vice versa in a straight stream compared to the case of inductor component 100. This configuration allows a larger amount of hot air, a hot atmosphere, generated by a reflow furnace to blow more easily on depressions 41A and 41B of external electrodes 34A and 34B, thereby facilitating the heating of external electrodes 34A and 34B, and enhancing wettability of external electrodes 34A and 34B to solder.

In inductor component 300 according to the embodiment, bottom surface 12B of the package has step recess 40A and step recess 40B therein. Step recess 40A is connected to step recesses 39A and 39B and extends to side surface 12A. Step recess 40b is connected to step recesses 39A and 39B and extends to side surface 12C. Step recesses 40A and 40B allows hot air, a hot atmosphere, generated by a reflow furnace to flow more easily through depressions 41A and 41B of external electrodes 34A and 34B, thereby facilitating the heating of external electrodes 34A and 34B, and enhancing wettability of external electrodes 34A and 34B to solder. In inductor component 300 according to the embodiment, bottom surface 12B of package 212 may necessarily have one of step recesses 40A and 40B therein.

Step recess 39A is connected to depression 41A of external electrode 34A. Step recess 39B is connected to depression 41B of external electrode 34B.

Step recess 39B is connected to step recess 39A.

Bottom surface 12B of package 212 has step recess 40A therein that communicates with step recess 39B and step recess 39A and that extends to side surface 12A.

Bottom surface 12B of package 212 has step recess 40B therein that communicates with both step recess 39B and step recess 39A and that extends to side surface 12C.

### INDUSTRIAL APPLICABILITY

An inductor component according to the present invention facilitating the heating of external electrodes during the inductor component is subjected to reflow soldering, for use in high electric-current applications. This results in enhanced wettability of the external electrodes to solder.

### REFERENCE MARKS IN DRAWINGS

11 coil
11A end (first end)
11B end (second end)
11C conductive wire
12 package
12A side surface (first side surface)
12B bottom surface
12C side surface (second side surface)
12D top surface
12E side surface (third side surface)
12F side surface (fourth side surface)
15A dimple (first dimple)
15B dimple (second dimple)
30A projection (first projection)
30B projection (second projection)
33A cutout (first cutout)
33B cutout (second cutout)
34A external electrode (first external electrode)
34B external electrode (second external electrode)
36A step recess (first step recess)
36B step recess (second step recess)
37A step recess (third step recess)
37B step recess (fourth step recess)
38A step recess (fifth step recess)
38B step recess (sixth step recess)
39A step recess (third step recess)
39B step recess (fourth step recess)
40A step recess (fifth step recess)
40B step recess (sixth step recess)
41A depression (first depression)
41B depression (second depression)
42A, 42B non-recessed portion
144A-144D bent portion
244A-244D bent portion

1. An inductor component comprising:
a package having a bottom surface, a top surface, a first side surface, a second side surface, a third side surface, and a fourth side surface, the top surface being opposite to the bottom surface, the first side surface being connected to both the bottom surface and the top surface, the second side surface being connected to the bottom surface and the top surface, the second side surface being opposite to the first side surface, the third side surface being connected to the bottom surface, the top surface, the first side surface, and the second side surface, the fourth side surface being connected to the bottom surface, the top surface, the first side surface, and the second side surface, the fourth side surface being opposite to the third side surface;
a coil embedded in the package, the coil being made of a wound conductive wire having a first end and a second end;
a first external electrode extending from the first end of the conductive wire of the coil, being led out from the first side surface, being bent toward the bottom surface, and being bent to extend along from the first side surface through the bottom surface to the second side surface toward the top surface; and
a second external electrode extending from the second end of the conductive wire of the coil, being led out from the first side surface, being bent toward the bottom surface, and being bent to extend along from the first side surface through the bottom surface to the second side surface toward the top surface, wherein
the bottom surface of the package has a first step recess therein sinking toward the top surface, opening to the third side surface, and contacting the first external electrode,
the bottom surface of the package further has a second step recess therein sinking toward the top surface, opening to the fourth side surface, and contacting the second external electrode,
a first dimple is provided in the package in the first step recess at a portion of the first step recess overlapping the first external electrode,
the first external electrode includes a first projection curved to protrude into the first dimple,
a second dimple is provided in the package in the second step recess at a portion of the second step recess overlapping the second external electrode,
the second external electrode includes a second projection curved to protrude into the second dimple,
the bottom surface further has a third step recess therein connected to the first step recess and sinking toward the top surface, and
the bottom surface further has a fourth step recess therein connected to the second step recess and sinking toward the top surface.

2. The inductor component of claim 1, wherein
the third step recess is connected to the first side surface, and
the fourth step recess is connected to the first side surface.

3. The inductor component of claim 1, wherein
the bottom surface further has a fifth step recess therein which is connected to the first step recess and which sinks toward the top surface,
the bottom surface further has a sixth step recess therein which is connected to the second step recess and which sinks toward the top surface,
the third step recess is not connected to the fifth step recess, and
the fourth step recess is not connected to the sixth step recess.

4. The inductor component of claim 3, wherein
the first external electrode has a first depression sinking toward the first dimple,
the second external electrode has a second depression sinking toward the second dimple,
the third step recess and the fifth step recess are connected to the first depression of the first external electrode, and
the fourth step recess and the sixth step recess are connected to the second depression of the second external electrode.

5. The inductor component of claim 1, wherein
the first external electrode has a first depression therein which sinks toward the first dimple and which is connected to the third step recess, and
the second external electrode has a second depression therein which sinks toward the second dimple and which is connected to the fourth step recess.

6. The inductor component of claim 5, wherein
the fourth step recess is connected to the third step recess, and
the bottom surface of the package further has a fifth step recess therein communicating with the fourth step recess and the third step recess, the fifth step recess extending to the first side surface of the package.

7. The inductor component of claim 6, wherein the bottom surface of the package further has a sixth step recess therein communicating with the fourth step recess and the third step recess, the sixth step recess extending to the second side surface of the package.

8. The inductor component of claim 5, wherein
the fourth step recess is connected to the third step recess, and
the bottom surface of the package further has a fifth step recess therein communicating with the fourth step recess and the third step recess, the fifth step recess extending to the second side surface of the package.

9. The inductor component of claim 1, wherein
the top surface of the package has a first cutout and a second cutout provided therein,
the first external electrode extends to as the first cutout of the top surface, and
the second external electrode extends to the second cutout of the top surface.

10. The inductor component of claim 1, wherein the package is made of magnetic material.
